(19) United States
(12) Patent Application Publication
(10) Pub. No.: US 2005/0055834 A1
(43) Pub. Date: Mar. 17, 2005

(54) Electric hair trimmer

(75) Inventors: Aik Pin Cheah, Hong Kong (CN); Kwok Nam Shek, Hong Kong (CN)

Correspondence Address: ALIX YALE & RISTAS LLP, 750 MAIN STREET, SUITE 1400, HARTFORD, CT, 06103, US

(73) Assignee: Chiaphua Industries Limited

(21) Appl. No.: 10/663,930

(22) Filed: Sep. 16, 2003

(51) Int. Cl. B26B 19/02

(52) U.S. Cl. 30/210

(57) ABSTRACT

An electric hair trimmer includes a housing with a handle and a head extending from the handle. Two fixed arrays of cutting teeth are attached to the head and face in opposed directions away from one another. Two movable arrays of cutting teeth face in opposite directions away from one another and each cooperates with a respective one of the fixed arrays of cutting teeth. An electric motor is located within the housing and affects movement of the two movable arrays of cutting teeth. The hair trimmer is designed for self-use in trimming one's hair and can be grasped by either hand and moved back and forth across the scalp somewhat in a brushing manner.

### BACKGROUND OF THE INVENTION

The present invention relates to electric hair trimmers. More particularly the invention relates to an electric hair trimmer having laterally opposed cutting teeth enabling the hair trimmer to be grasped by either hand during self-trimming of one's hair.

Known electric hair trimmers comprise a handle housing one or more batteries, a static cutting blade and a motor-driven cutting blade. The motor-driven blade slides back and forth upon a fixed cutting blade at a head of the trimmer such that overlapping teeth of the two blades interact with one another to sever hair against which the blades are pushed. The teeth point forward of the trimmer's head requiring that the handle be pushed in a direction towards the head during use. Such known trimmers employ a selected one of a range of combs of different depth, depending upon the length to which one desires his or her hair to be cut.

The above-described electric hair trimmers do not lend themselves readily to self-use in cutting one's own hair.

### OBJECTS OF THE INVENTION

It is an object of the present invention to overcome or substantially ameliorate the above disadvantage and/or more generally to provide an improved electric hair trimmer.

### DISCLOSURE OF THE INVENTION

There is disclosed herein an electric hair trimmer comprising:
a housing having a handle and a head extending from the handle,
two fixed arrays of cutting teeth attached to the head and facing away from one another,
two movable arrays of cutting teeth facing away from one another and each cooperating a respective one of said fixed arrays of cutting teeth, and
an electric motor located within the housing and affecting movement of the two movable arrays of cutting teeth.

Preferably the two fixed arrays of cutting teeth and the two movable arrays of cutting face in laterally opposed directions.

Preferably the two fixed arrays of cutting teeth are formed on a single blade fixed to the head.

Preferably the two movable arrays of cutting teeth are formed on a single moving blade movable with respect to the head.

Preferably the electric hair trimmer further comprises a pivot member mounted to the head and co-operating with the motor to transmit rotary output of the motor to linear oscillation of the moving blade.

Preferably, the electric hair trimmer further comprises a motor output shaft having an eccentric boss and the pivot member has an opening in which the boss is received and with which the boss engages.

Preferably the moving blade has a coupling with which an arm of the pivot member engages.

Preferably the head has a number of exposed slots in laterally opposed faces thereof and the electric hair trimmer further comprises a comb attachment receivable by selected opposed pairs of the slots to set a desired hair cutting length.

### BRIEF DESCRIPTION OF THE DRAWINGS

A preferred form of the present invention will now be described by way of example with reference to the accompanying drawings, wherein:

FIG. 1 is a schematic perspective cut-away illustration of an electric hair trimmer,

FIG. 2 is a schematic perspective illustration of an electric motor, drive transmission and cutting blades,

FIG. 3 is a schematic plan view of the cutting blades,

FIG. 4 is a schematic perspective view of the cutting blades,

FIG. 5 is a schematic parts-exploded perspective illustration of the cutting blades,

FIG. 6 is another schematic perspective illustration of the electric motor, drive transmission and cutting blades,

FIG. 7 is a schematic detailed perspective illustration of the motor output shaft, transmission and coupling component of the movable cutting blade,

FIGS. 8 to 10 are schematic elevational illustrations of the components depicted in FIG. 2 at different stages during a rotation of the motor output shaft,

FIG. 11 is a schematic elevational view of the hair trimmer, and

FIGS. 12a to 12c are schematic elevational views of a comb attachment for the hair trimmer of FIG. 11.

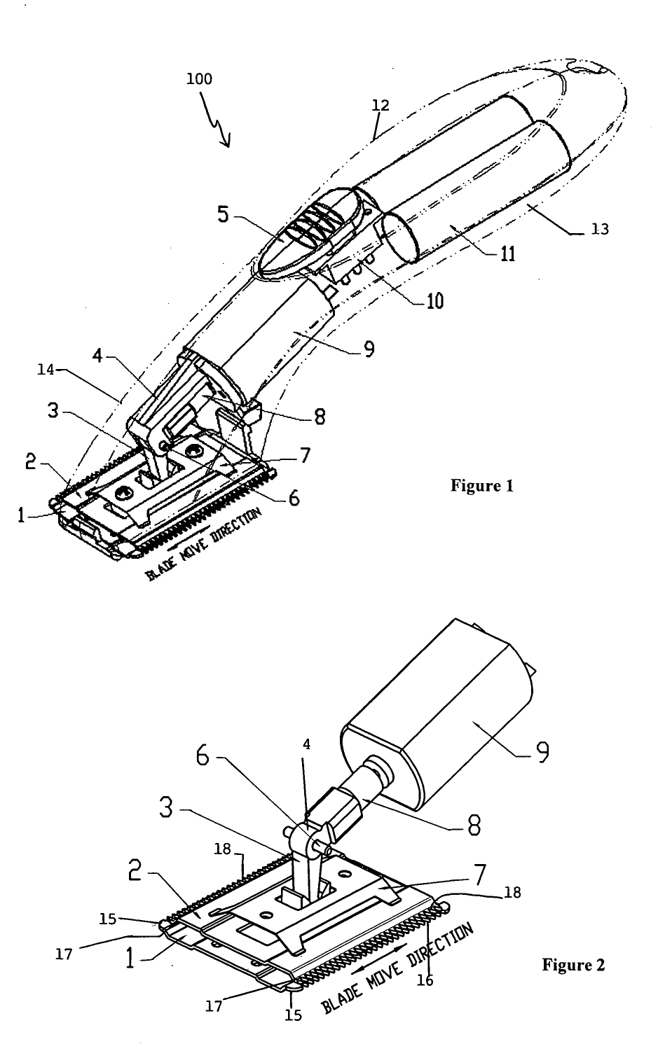

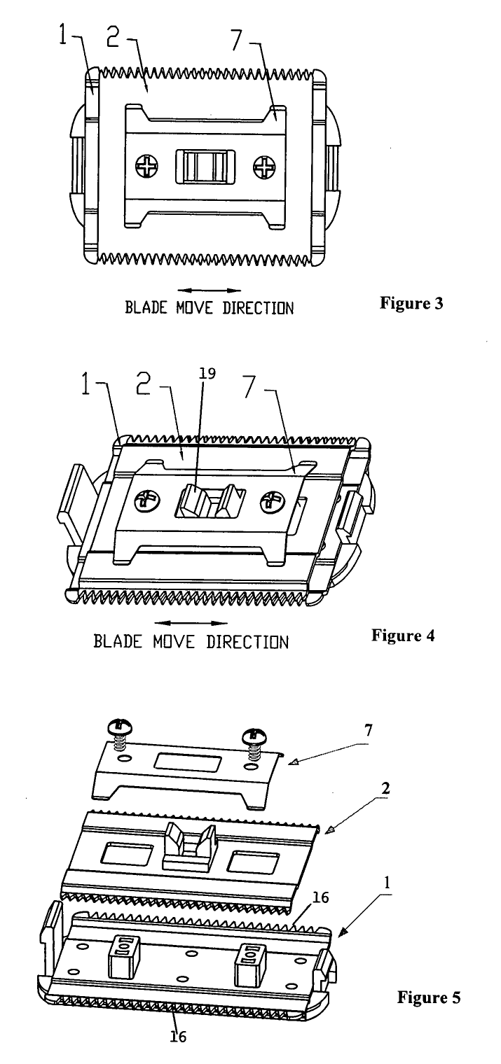

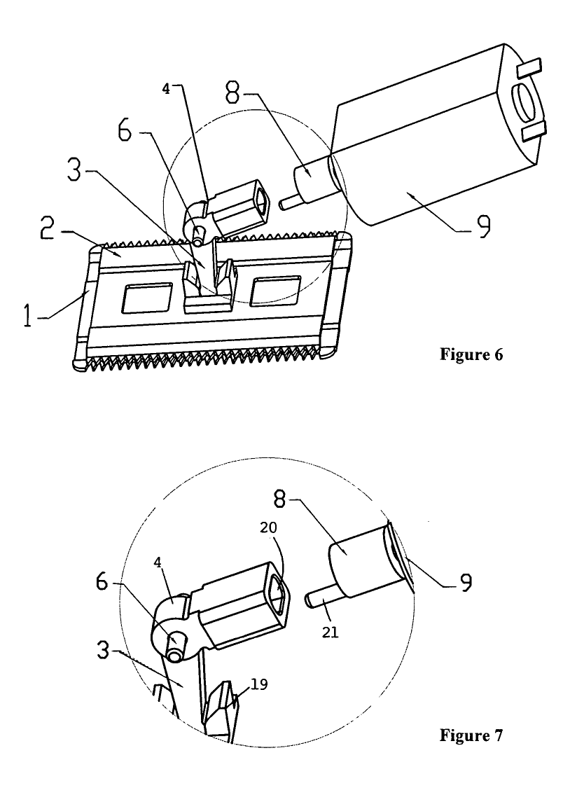

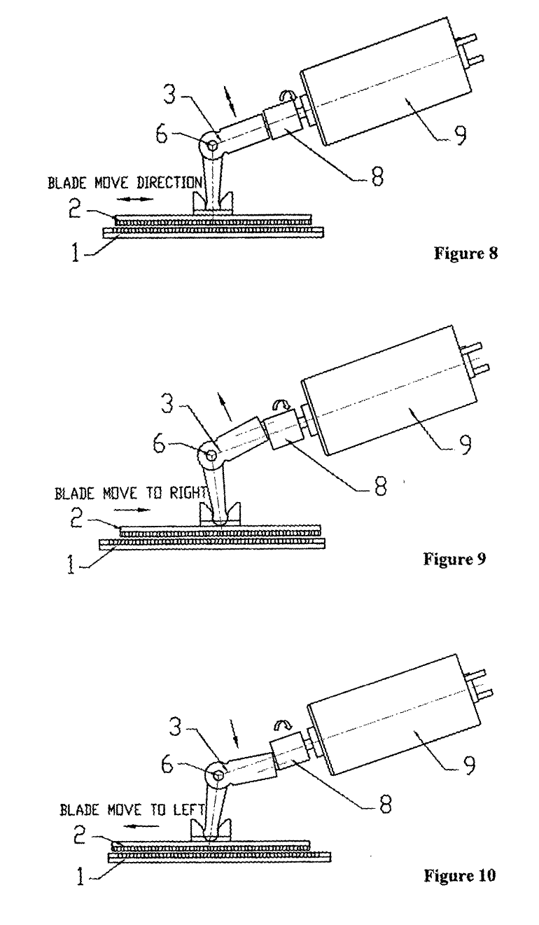

### DESCRIPTION OF THE PREFERRED EMBODIMENT

In the accompanying drawings there is depicted schematically an electric hair trimmer 100. The hair trimmer comprises a housing 12 typically formed of moulded plastics material. The housing 12 comprises a handle 13 and a head 14. A number of batteries 11 are located within the housing 13 and there is a switch 10 operated by a thumb actuator 5 to convey electric power from the batteries 13 to a motor 9 positioned within the handle just behind the head 14.

Secured within the head 14 is a fixed blade 1 having laterally opposed linear arrays 15 of teeth 16. Overlaying the fixed blade rule 1 is a moving blade 2 having laterally opposed linear arrays 17 of cutting teeth 18. The cutting teeth 18 move back and forth against the cutting teeth 16. To this end, there is a spring plate 7 screwed down upon the moving plate 2 which locates a coupling 19 in fixed relationship with the moving plate. Both the fixed and moving plates and the spring plate are typically fabricated from stainless-steel.

There is a pivot member 4 attached by its axle 6 to the interior of the head 14. The pivot member 4 has an integral arm 3 that extends into the coupling 19. The pivot member 4 also has an opening 20 into which an eccentric boss 21 of a motor output shaft 8 is received.

Upon manipulation of thumb actuator 5, the switch 10 closes an electric circuit to activate the electric motor 9. The output shaft 8 rotates such that the eccentric boss 21 moves in the orbital fashion to effect pivotal movement of the pivot member 4 due to its interaction with the opening 20. As a result, the arm 3 causes back and forth linear oscillation of the moving plate 2.

The trimmer's handle 13 can be grasped by either the left or right hand and manipulated somewhat like a hairbrush in a left or right motion (i.e. a motion transverse to longitudinal extent of the handle 13).

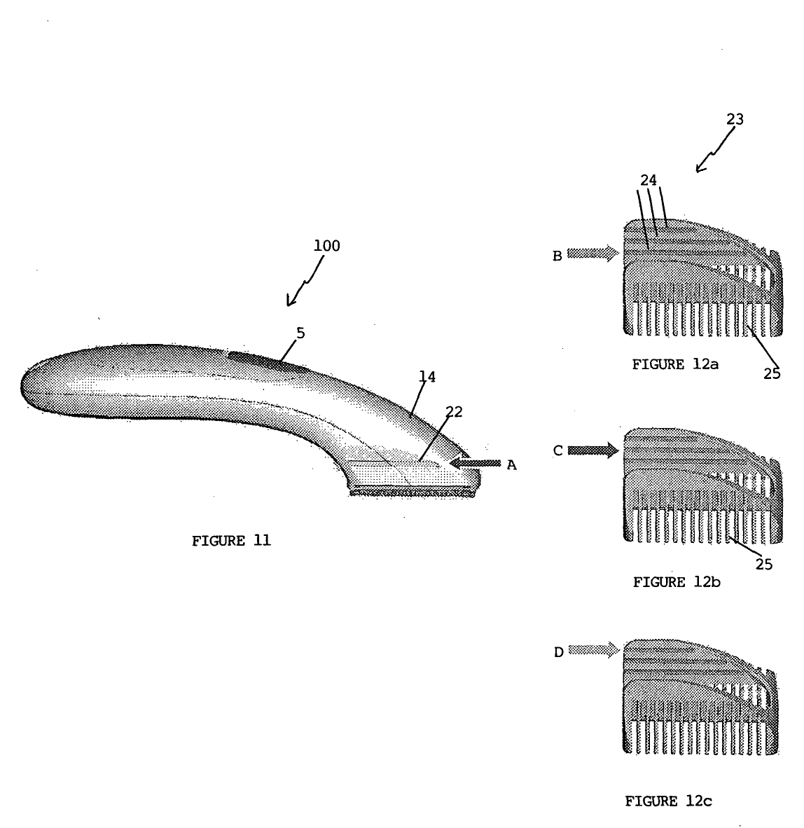

As shown in FIG. 11, the hair trimmer 100 has at its head 14 a pair of slots 22 in the plastics moulded case. One such slot is located at each laterally opposed side of the head 14.

A comb attachment 23 is shown in FIGS. 12a to 12c. The comb attachment has three different ribs 24 at each side for selective alignment and receipt within the slots 22 of the head 14. Moreover, the comb attachment 23 can be attached to the head 14 by application thereof in the direction indicated by arrow A in FIG. 11. Said alternatively, the head 14 can be attached to the comb attachment 23 by application of the slots 22 as indicated by either arrow A, B, or C to one of the ribs 24 as indicated in FIG. 12. As a result, the comb teeth 25 are fixed at one of three predefined settings—depending on the desired style of hair trimming to be achieved by the trimmer.

It should be appreciated that modifications and alterations obvious to those people skilled in the art are not to be considered as beyond the scope of the present invention. For example, alternative means of transmitting rotary output of the motor to linear oscillation of the moving blade can be adopted. Furthermore, the slots 22 might be replaced by ribs and the ribs 24 might be replaced by slots.

1. An electric hair trimmer comprising:
a housing having a handle and a head extending from the handle,
two fixed arrays of cutting teeth attached to the head and facing away from one another,
two movable arrays of cutting teeth facing away from one another and each cooperating with a respective one of said fixed arrays of cutting teeth, and
an electric motor located within the housing and affecting movement of the two movable arrays of cutting teeth.

2. The electric hair trimmer of claim 1 wherein the two fixed arrays of cutting teeth and the two movable arrays of cutting face in laterally opposed directions.

3. The electric hair trimmer of claim 1 wherein the two fixed arrays of cutting teeth are formed on a single blade fixed to the head.

4. The electric hair trimmer of claim 1 wherein the two movable arrays of cutting teeth are formed on a single moving blade movable with respect to the head.

5. The electric hair trimmer of claim 4 further comprising a pivot member mounted to the head and co-operating with the motor to transmit rotary output of the motor to linear oscillation of the moving blade.

6. The electric hair trimmer of claim 5 further comprising a motor output shaft having an eccentric boss and the pivot member has an opening in which the boss is received and with which the boss engages.

7. The electric hair trimmer of claim 5 wherein the moving blade has a coupling with which an arm of the pivot member engages.

8. The electric hair trimmer of claim 1 wherein the head has a number of exposed slots in laterally opposed faces thereof and the electric hair trimmer further comprises a comb attachment receivable by selected opposed pairs of the slots to set a desired hair cutting length.
